(19) United States
(12) Patent Application Publication
(10) Pub. No.: US 2005/0079037 A1
(43) Pub. Date: Apr. 14, 2005

(54) Lifting and carrying apparatus for vehicles

(76) Inventor: William M. Boyd, Shreveport, LA (US)

Correspondence Address: John M. Harrison, 2139 E. Bert Kouns, Shreveport, LA, 71105, US

(21) Appl. No.: 10/963,320

(22) Filed: Oct. 12, 2004

Related U.S. Application Data
(60) Provisional application No. 60/510,574, filed on Oct. 14, 2003.

(51) Int. Cl. B60P 9/00

(52) U.S. Cl. 414/462

(57) ABSTRACT

A lifting and carrying apparatus for vehicles such as all-terrain vehicles, which apparatus includes a typically wheeled lift frame hingedly attached to the bottom ends of a pair of parallel, downwardly-extending frame legs connected at the opposite ends by a spacer bar. A fixed frame mount slidably receives the frame legs for up and down lift frame travel and the frame mount is mounted on a receiver bracket fitted with a winch and a roller positioned forwardly of the winch. The receiver bracket is fixed to the frame of an all-terrain vehicle to facilitate raising and lowering the lift frame and the frame legs in the frame mount using a lift line or strap attached to the lift frame and extending over the roller to the winch, and operating the winch. The lift frame can also be folded adjacent to the frame legs by either repositioning the lift strap to the extremity of the lift frame and operating the winch to close the lift frame on the frame legs or pivoting the lift frame by hand into the folded configuration against the frame legs. The roller and the winch can be interchanged in the receiver bracket to facilitate low profile storage of the folded lifting and carrying apparatus when it is not in use.

### CROSS-REFERENCE TO RELATED APPLICATIONS

This application claims the benefit of and incorporates by reference copending U.S. Provisional Application Ser. No. 60/510,574, Filed Oct. 14, 2003.

### SUMMARY OF THE INVENTION

This invention relates to lifting and carrying devices for attachment to vehicles such as all-terrain vehicles and more particularly, to a lifting and carrying apparatus which is typically removably attached to an all-terrain vehicle and includes a typically wheeled lift frame that is preferably pivotally or hingedly attached to a vertical frame designed to move up and down in a frame mount attached to the all-terrain vehicle. In a preferred embodiment the frame mount is fixed to a receiver bracket fitted with a roller and a winch, which receiver bracket is removably attached to the rear of the all-terrain vehicle by means of a vehicle mount bracket. Operation of the winch selectively extends and retracts a lift strap or line extending over the roller and attached to the lift frame, causing the vertical frame and the lift frame to be selectively raised and lowered in concert. In another preferred embodiment of the invention the bottom ends of the frame leg elements of the vertical frame are hinged to the lift frame to facilitate folding of the lift frame against the vertical frame when the lifting and carrying apparatus is not in use, as during transportation, or when it is placed in storage. An optimum storage configuration can be effected in this regard by reversing the positions of the winch and roller on the receiver bracket to facilitate storage of the devices in minimum space. The receiver bracket can be adapted to mount various upper and lower frame brackets in addition to a vehicle mount bracket for removably securing the lifting and carrying apparatus on the rear end of a vehicle such as an all-terrain vehicle.

### BRIEF DESCRIPTION OF THE DRAWINGS

The invention will be better understood by reference to the accompanying drawings, wherein:

FIG. 1 is a front perspective view of a preferred wheelless embodiment of the lifting and carrying apparatus of this invention, more particularly illustrating the lift frame in open, or functional configuration and extended downwardly by operation of a winch;

FIG. 1A is an exploded view of the lifting and carrying apparatus illustrated in FIG. 1;

FIG. 1B is a perspective view of an alternative preferred wheeled embodiment of the lifting and carrying apparatus of this invention;

FIG. 1C is a rear view of the wheeled lifting and carrying apparatus illustrated in FIG. 1B;

FIG. 2 is a rear perspective view of the lifting and carrying apparatus illustrated in FIG. 1 with the lift frame raised;

FIG. 3 is a rear perspective view of the lifting and carrying apparatus illustrated in FIG. 2 with the lift frame illustrated in lowered configuration;

FIG. 4 is a front perspective view of the lifting and carrying apparatus illustrated in FIGS. 1, 2 and 3, with the lift frame in folded configuration;

FIG. 5 is a front view of the folded lifting and carrying apparatus illustrated in FIG. 4;

FIG. 6 is a right side view of the lifting and carrying apparatus illustrated in FIGS. 4 and 5;

FIG. 7 is a right side view of the wheeled lifting and carrying apparatus illustrated in FIGS. 1B and 1C, illustrating the lifting function of the lift frame; and

FIG. 8 is a right side view of the wheeled lifting and carrying apparatus illustrated in FIG. 7, illustrating the pivoting function of the lift frame.

### DESCRIPTION OF THE PREFERRED EMBODIMENTS

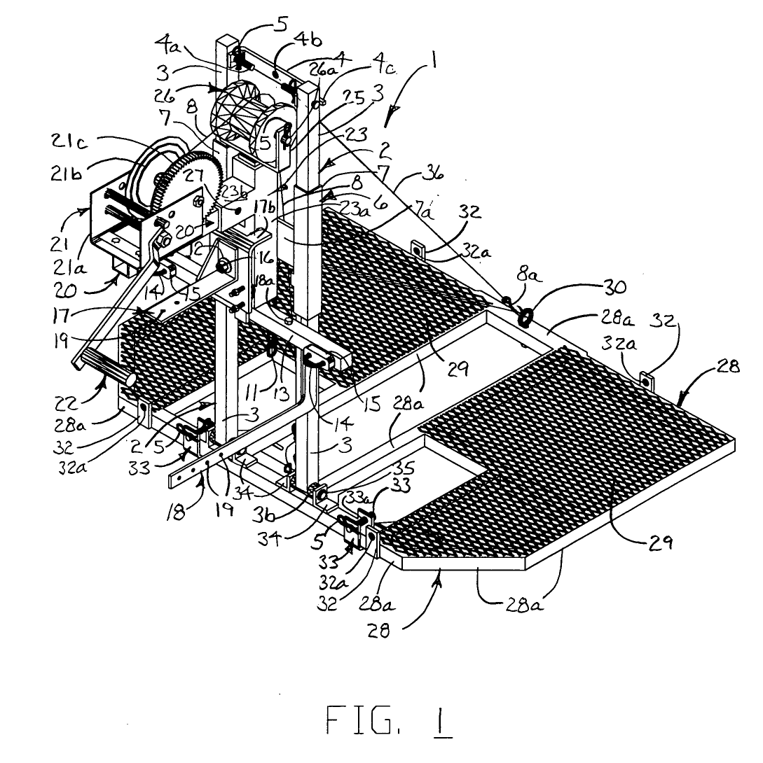

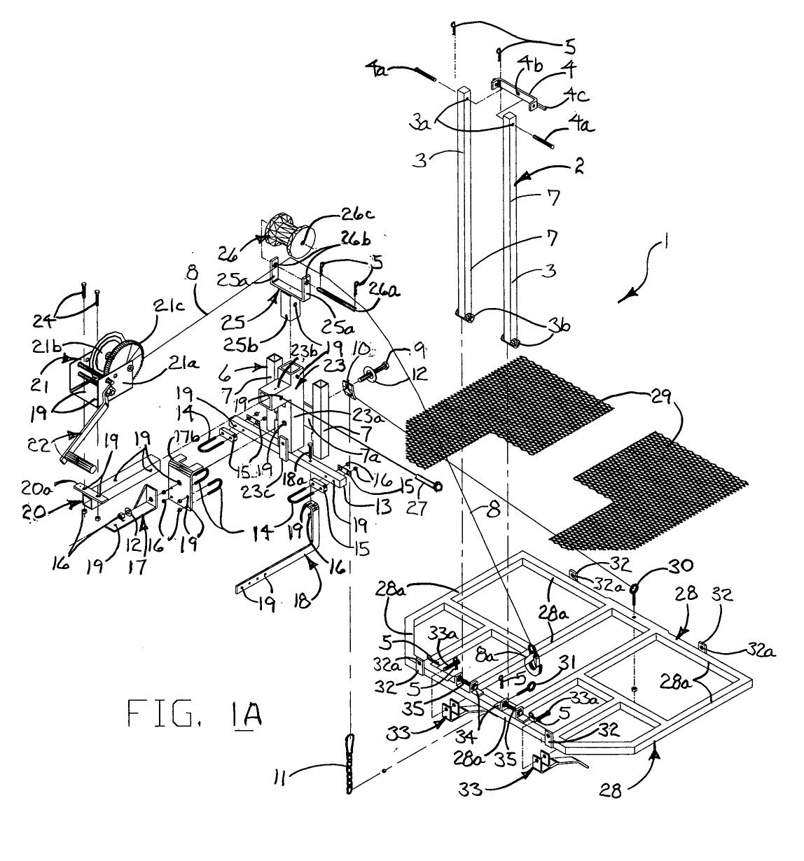

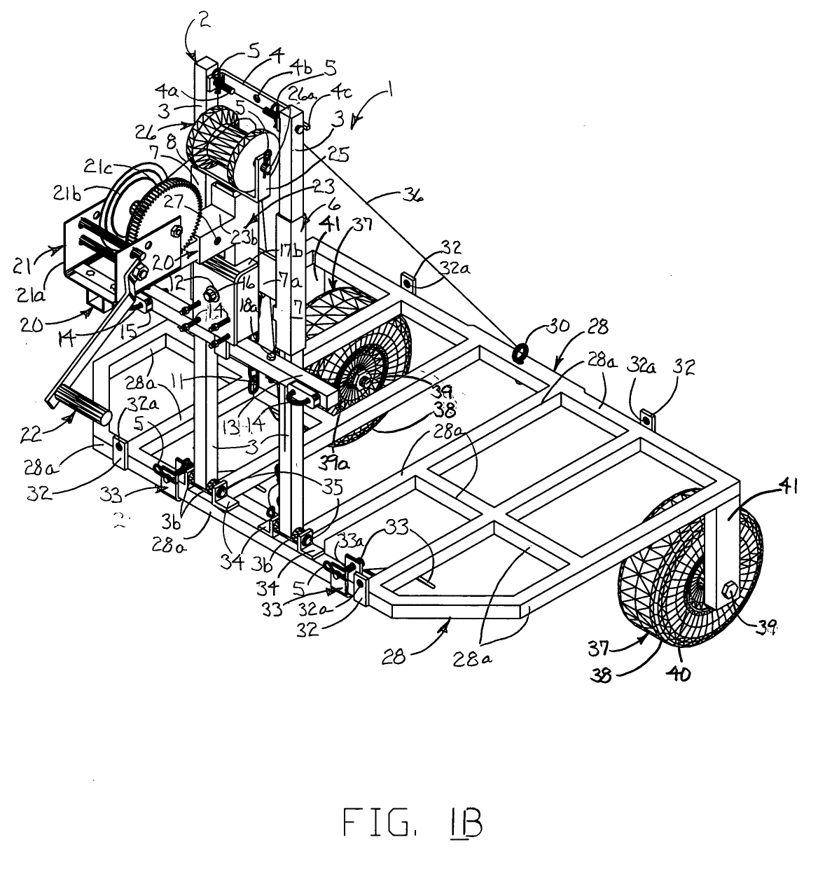

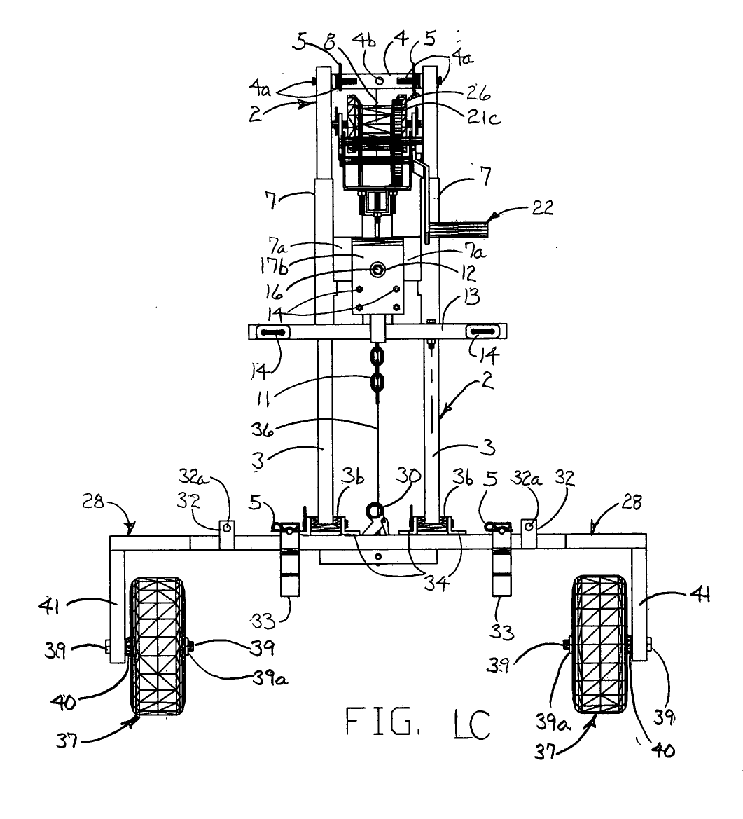

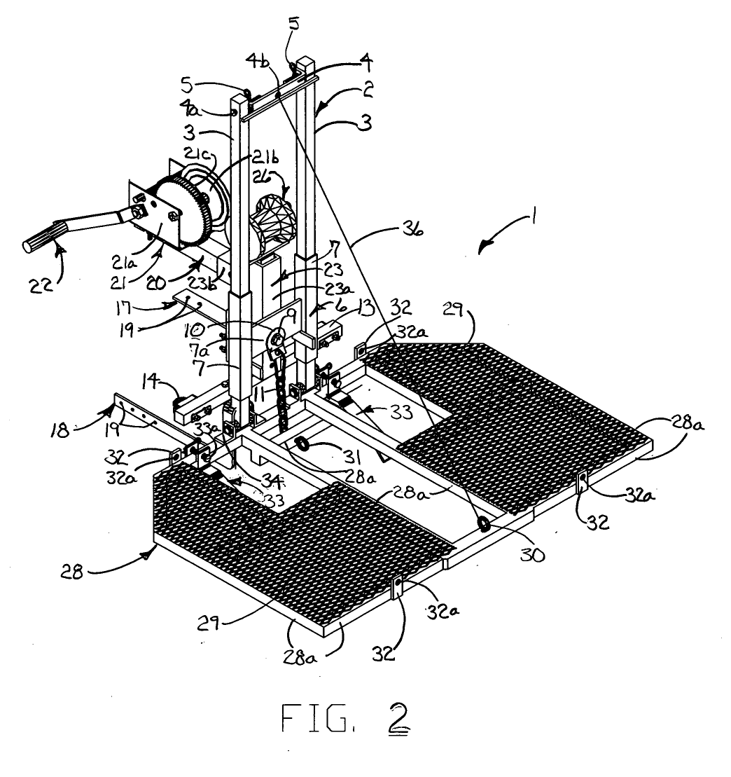

Referring initially to FIGS. 1, 1A and 2 of the drawings, in a preferred embodiment the lifting and carrying apparatus of this invention is generally characterized and illustrated by reference numeral 1. A wheeled embodiment of the device is illustrated in FIGS. 1B and 1C, in an alternative design. The lifting and carrying apparatus 1 may be adapted for mounting on the rear of an all-terrain vehicle or a pickup truck or other vehicle (not illustrated), depending upon the appropriate brackets utilized to secure the apparatus to the vehicle. In a preferred embodiment the lifting and carrying apparatus is designed to mount on the back of an all-terrain vehicle or ATV, (not illustrated) and includes a vertical frame 2, characterized by a pair of parallel frame legs 3, each having leg openings 3a at the top thereof (FIG. 1A) for mounting a spacer bar 4, having a spacer bar brace 4c, thereon, using spacer bar mount bolts 4a, typically seated in place by means of retainer pins 5, as illustrated in FIGS. 1, 1A and 2. The bottom ends of the frame legs 3 are each fitted with a cylindrical leg mount 3b, which seats between a pair of facing L-shaped frame leg mount brackets 34 that are welded to, or otherwise mounted on, the forward one of the lift frame tubing members 28a of the lift frame 28, as further illustrated in FIGS. 1 and 1A. A pair of leg mount bolts 35 (FIG. 1A) pivotally or hingedly connect the respective leg mounts 3b to the corresponding frame leg mount brackets 34. Accordingly, the vertically-oriented frame legs 3 are fixed in the vertical frame 2 and the lift frame 28 is pivotally or hingedly connected to the bottom ends of the respective frame legs 3 at the leg mounts 3b and corresponding leg mount brackets 34.

The frame legs 3 of the vertical frame 2 are slidably disposed in the corresponding frame mount legs 7 of a frame mount 6, wherein a box frame or plate frame mount leg spacer 7a spaces the frame mount legs 7, as illustrated in FIGS. 1, 1A and 2 of the drawings. As further illustrated in FIGS. 1 and 1A, the frame mount leg spacer 7a extends between and spaces the frame mount legs 7 and is fitted with a bolt opening (not illustrated) that aligns with a corresponding bracket opening 19 in the receiver bracket leg 23a of a receiver bracket 23, positioned adjacent to the frame mount leg spacer 7a, as further illustrated in FIG. 1A. Furthermore, a spacer bracket 17b is fitted with another bracket opening 19 that aligns with the bracket opening 19 in the receiver bracket leg 23a and in the corresponding bolt opening (not illustrated) provided in the frame mount leg spacer 7a, to fixedly mount the receiver bracket 23 and the spacer bracket 17b, as well as a chain mount bracket 10, on the frame mount leg spacer 7a, using a spacer mount bolt 9, a washer 12 and a nut 16, as illustrated in FIG. 1A of the drawings. In a preferred embodiment a pair of wheels 37 include inflatable or solid tires 38, and are mounted on corresponding wheel mounts 41, which are bolted or welded to the lift frame 28, as illustrated in FIGS. 1B and 1C of the drawings. The heads of the respective axle bolts 39 that mount the wheels 37 on the respective wheel mounts 41 are typically welded to the wheel mounts 41 and project through the corresponding wheel hubs 40 of the wheels 37 and receive the axle mount bolt nuts 39a. The wheels 37 are particularly useful to prevent excessive stress on the lift frame 28 and the vertical frame 2 when a heavy load is placed on the lift frame 28. The wheels 37 also serve to facilitate easy transportation of such loads over uneven terrain, such as in wooded areas. It will be appreciated by those skilled in the art that a single wheel 37 can be rotatably mounted to the rear center of the lift frame 28, in an alternative wheel mount, depending upon the load to be placed on the lift frame 28.

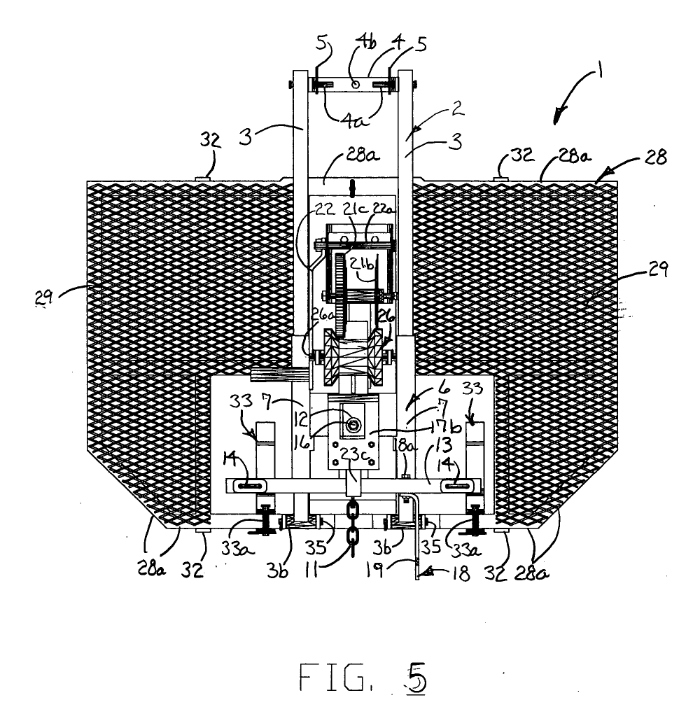

Referring again to FIGS. 1-5 of the drawings, a winch 21 is fitted with a winch frame 21a that houses a drum gear 21c, provided on a winch drum 21b and includes a conventional handle gear 22a (FIG. 5) that meshes with the drum gear 21c to facilitate rotation of the winch drum 21b by operation of a winch handle 22 in conventional fashion. The winch frame 21a is typically removably attached to an underlying winch mount bracket 20, having a top plate 20a (FIG. 1A) fitted with bracket openings 19 that align with corresponding bracket openings 19 located in the winch frame 21a, to receive corresponding winch mount bolts 24 and cooperating nuts 16 and removably secure the winch 21 on the top plate 20a of the winch mount bracket 20 (FIG. 1A). Furthermore, the winch mount bracket 20 is typically constructed of square tubing that is undersized to fit in a corresponding square tube opening in the receiver bracket 23b of the receiver bracket 23, to facilitate removably mounting the winch 21 on the receiver bracket 23, as further illustrated in FIGS. 1 and 1A of the drawings. This removable connection is typically effected by means of a receiver bracket pin or bolt 27 that extends through corresponding aligned bracket openings 19 in the respective winch mount bracket 20 and the receiving receiver bracket arm 23b of the receiver bracket 23. The receiver bracket pin or bolt 27 can be secured in position by a nut or retainer pin (not illustrated), as desired.

Similarly, referring again to FIGS. 1 and 1A of the drawings, a roller 26, which is typically characterized by a keel or spool roller, is rotatably mounted on a roller pin 26a, extending through spaced-apart roller pin openings 26b in the roller mount yoke arms 25a of a roller mount bracket 25 and through the aligned roller opening 26c in the roller 26 (FIG. 1A). The roller pin 26a is typically secured in place by means of a pair of retainer pins 5, as further illustrated in FIGS. 1 and 1A. The roller 26 is thusly seated between the parallel, upward-standing roller mount yoke arms 25a and a roller mount yoke leg 25b extends downwardly from the cross member of the roller mount yoke arms 25a and is typically constructed of undersized square tubing that fits in a larger square opening in the square tubing top end of the receiver bracket leg 23a of the receiver bracket 23. A bracket opening 19 is typically provided in the roller mount yoke leg 25b for alignment with a corresponding bracket opening 19 located in the top end of the receiver bracket leg 23a and insertion of a pin (not illustrated) to removably secure the roller mount yoke 25 and the roller 26 in the top end of the roller bracket leg 23a. However, because of the vertical position of the roller mount yoke leg 25b downwardly in the upward-standing vertical receiver bracket leg 23a of the receiver bracket 23, gravity will normally secure the roller mount yoke 25 in place on the receiver bracket 23 without the necessity of using a pin, bolt or other connector.

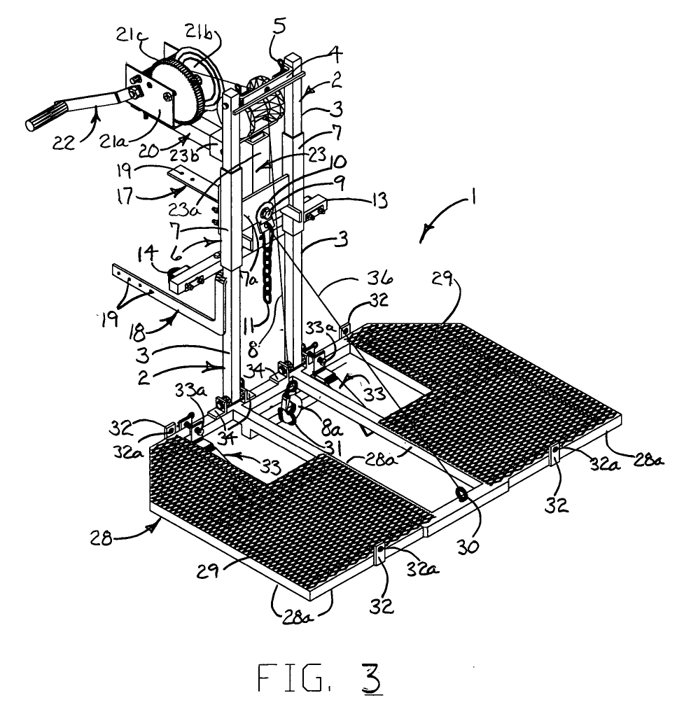

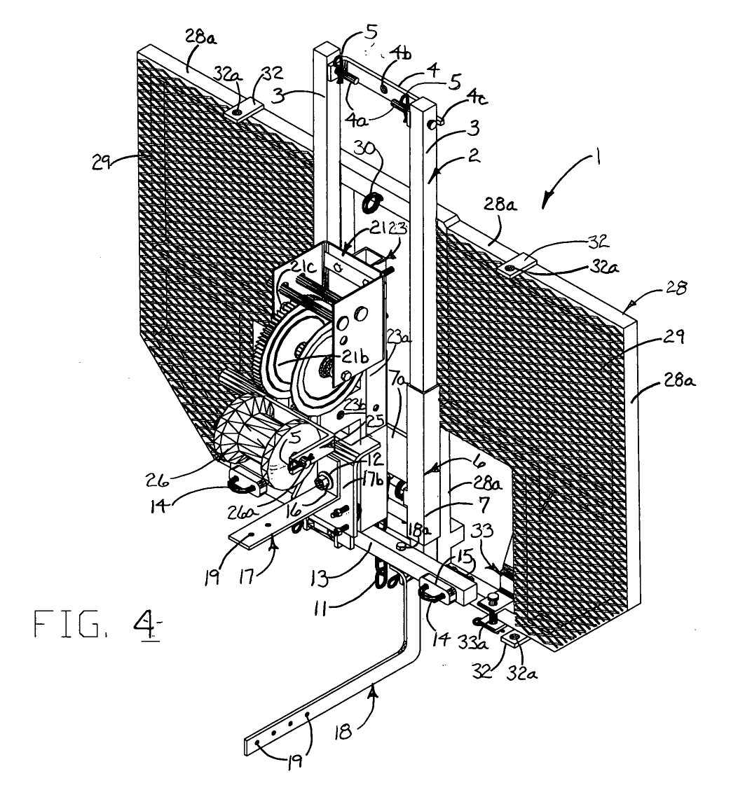

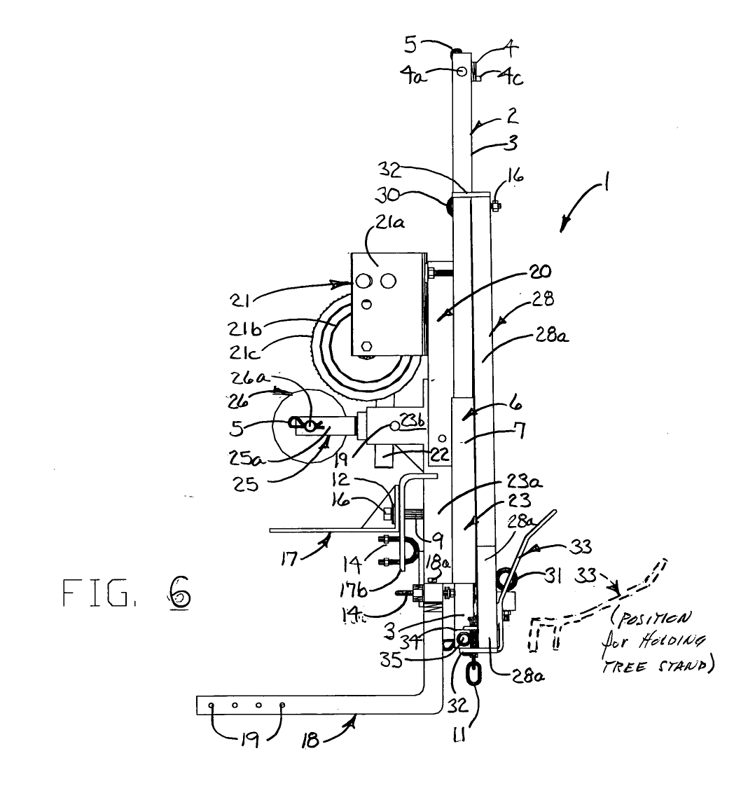

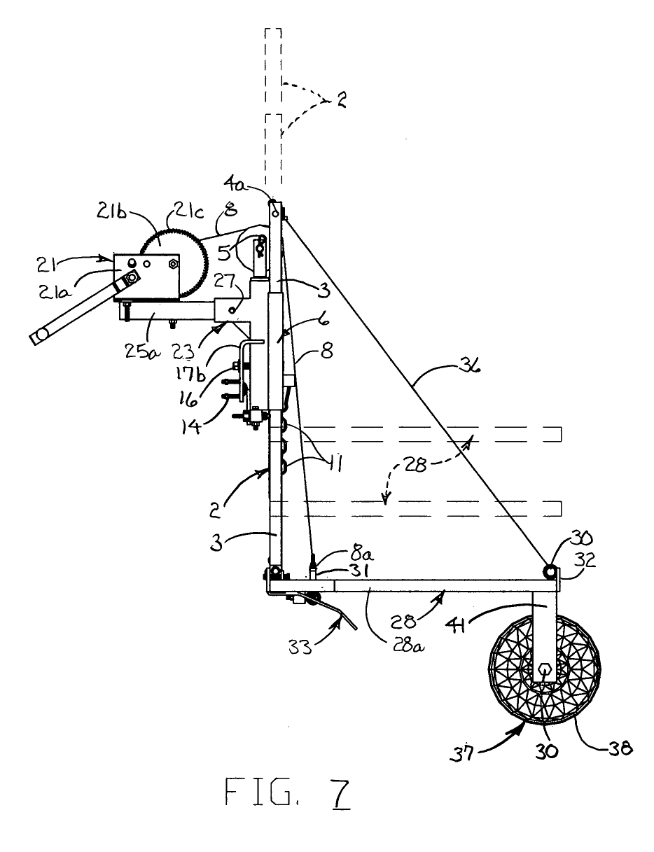

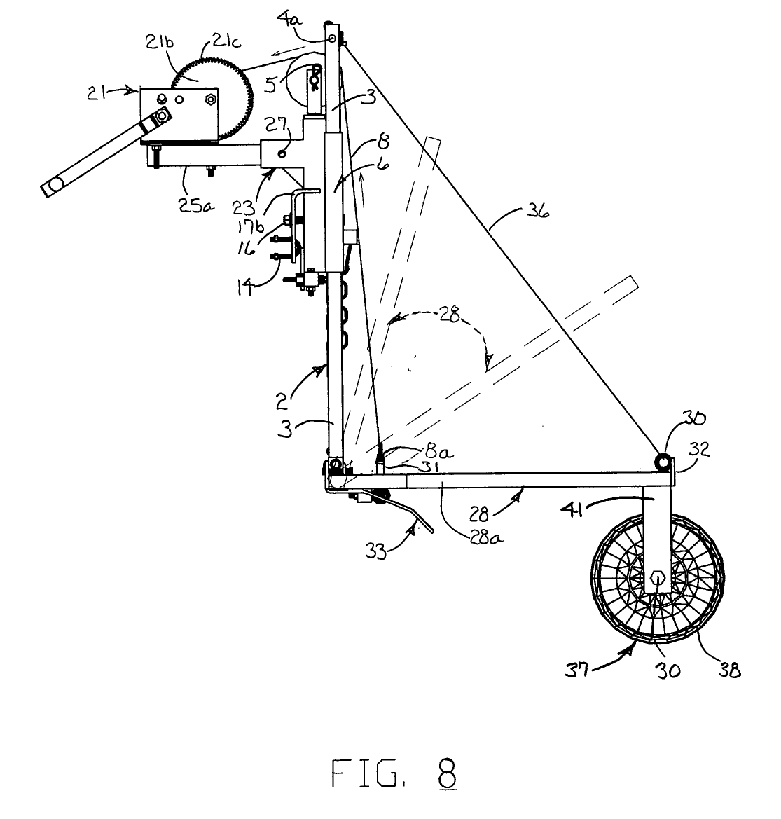

As further illustrated in FIGS. 1, 1A, 3, 7 and 8 of the drawings, a line, cable or strap 8 is typically wound on the winch drum 21b of the winch 21 and extends over the roller 26 and downwardly to a desired position, typically to the inner eye bolt 31 (FIGS. 1A and 7) for attachment to the underlying lift frame 28 and raising and lowering the lift frame 28, as illustrated in phantom in FIG. 7 and as hereinafter further described. Alternatively, under circumstances where it is desired to fold the lift frame 28 against the vertically-oriented vertical frame 2, (FIG. 8) the free end of the strap 8 may be moved from the inner eye bolt 31 and secured, typically by means of a strap hook 8a, to the outer eye bolt 30, secured to the outer one of the frame tubing 28a of the inner frame 28. Operation of the winch 21 by turning the winch handle 22 in conventional fashion pivots the lift frame 28 from the position illustrated in FIG. 1 through the locations illustrated in phantom in FIG. 8, to the position illustrated in FIGS. 4, 5 and 6 of the drawings. The lift frame 28 can then be secured in place in any desired manner. Under circumstances where it is desired to raise and lower the lift frame 28, including the vertical frame 2, with respect to the frame carriage 6, the winch strap 8 can be attached, typically by means of the strap hook 8a, to the inner eye bolt 31, as further illustrated in FIGS. 1A and 7, and as described above, and the winch 21 then operated as heretofore described to raise and lower the lift frame 28. More specifically, and referring now to FIGS. 2 and 3 of the drawings, under circumstances where it is desired to lower the lift frame 28 from the position illustrated in FIG. 2 to the position illustrated in FIG. 3, the winch strap 8 is connected to the inner eye bolt 31 and the winch 21 is operated in reverse to lower the lift frame 28 from the position illustrated in FIG. 2 to the position illustrated in FIG. 3. Conversely, when it is desired to raise the lift frame 28 from the position illustrated in FIG. 3 to the position illustrated in FIG. 2, the reverse operation of the winch 21 is accomplished to achieve this result.

Referring again to FIGS. 1-3, 7 and 8 of the drawings, under circumstances where it is desired to stabilize the lift frame 28 in any selected operating or static position and typically, the positions illustrated, a stabilizing bar, rod or flexible strap 36 can be attached by any suitable means, including a strap hook 8a or the like, at one end to the spacer bar opening 4b in the spacer bar 4 and the opposite end secured to the outer eye bolt 30, mounted on the outer frame tubing 28a of the lift frame 28. In FIG. 3 the stabilizing strap 36 extends between the chain mount bracket 10 and the outer eye bolt 30 and is utilized in this configuration only when the lift frame 28 is not being raised or lowered. The stabilizing strap 36 facilitates the application of greater loads to the lift frame 26, both during raising and lowering of the frame 26 by operation of the winch 21 (FIG. 2) and while static (FIG. 3). As further illustrated in FIGS. 7 and 8 and as heretofore described, heavy loads placed on the lift frame 28 are also stabilized, especially during transportation, by the wheels 37.

Accordingly, referring again to FIGS. 2, 1B and 1C of the drawings, under circumstances where it is desired to carry various objects, including game and other cargo (not illustrated) by operation of the ATV (not illustrated) with the lift frame 28 in the raised position, the free end of a bracket chain 11 (the other end of which is secured typically by means of the spacer mount bolt 9 and chain mount bracket 10 to the frame mount leg spacer 7a), can be attached to either end of the inner eye bolt 31 and the stabilizing strap 36 can be positioned as illustrated in FIG. 2, to facilitate additional strength in carrying such cargo. Moreover, under these circumstances, the lift frame 28 can be folded on the leg mount bolts 35 at the leg mounts 3b of the frame legs 3 by hand, without using the winch 21, if so desired.

As further illustrated in the drawings various types of brackets and attachments may be utilized to connect the lifting and carrying apparatus 1 to a vehicle such as an all-terrain vehicle (ATV) and typical of these is the upper frame bracket 17, connected to the spacer bracket 17b by means of the spacer mount bolt 9 and nut 16, as heretofore described. The L-shaped upper frame bracket 17 can then be attached to an ATV (not illustrated) by means of various bolts (not illustrated) by extending these bolts through corresponding bracket openings 19 in the extending end of the upper frame bracket 17 and through aligned bolt openings in the ATV frame to secure the upper frame bracket 17 to the rear end of the ATV. Furthermore, an optional lower frame bracket 18 (FIGS. 1, 1A and 2) is similarly provided with bracket openings 19 for attachment to an all-terrain vehicle, with the L-shaped opposite end of the lower frame bracket 18 secured to a vehicle mount bracket 13 that spans the vertical frame legs 3 and is secured to the receiver bracket 23 at a receiver bracket cleat 23c, as illustrated. In a typical embodiment the L-shaped lower frame bracket 18 is bolted to the vehicle mount bracket 13 by means of a lower frame bracket bolt 18a, which extends through aligned bracket openings 19 located in the short end of the lower frame bracket 18 and in the vehicle mount bracket 13 and is typically secured by a nut 16.

In another preferred embodiment of the invention the vehicle mount bracket 13 is itself attached to one of the bars or frame members of an all-terrain vehicle (not illustrated) by means of corresponding U-bolts 14, that typically extend through corresponding U-bolt spacers 15 and through bracket openings or slots 19 located in the vehicle mount bracket 13, where they are secured in place by corresponding nuts 16.

Referring again to FIGS. 1-4 of the drawings, various frame cleats 32, each having a cleat opening 32a, are welded or otherwise provided in spaced-apart locations on the frame tubing 28a of the lift frame 28 for receiving bungee cords, straps or other tie-down members (not illustrated) and securing various cargo on the lift frame 28. Furthermore, the optional expanded metal deck 29 (FIGS. 1-2), which is welded or otherwise secured to the frame tubing 28a of the lift frame 28, facilitates a strong, easily washed and cleaned supporting surface for cargo such as game and the like (not illustrated) while using the lifting and carrying apparatus 1. A pair of spaced-apart auxiliary brackets 33, each have a bifurcated mounting end, are provided for reversibly mounting on the frame tubing 28a by means of auxiliary bracket pins 33a and corresponding retainer pins 5 (FIGS. 1B and 1C). This facility allows equipment and gear such as climbing tree stands and the like to be strapped or lashed to the lifting and carrying apparatus 1 with ropes or bungee cords while resting on the projecting ends of the spaced-apart auxiliary brackets 33a.

As illustrated in FIGS. 1A, 4-6 and 8 of the drawings, the lift frame 28 can be positioned in the retracted or folded configuration as heretofore described, to facilitate transportation and storage. In the course of such storage, a minimum profile or width of the lifting and carrying apparatus 1 can be effected by reversing the positions of the winch 21 and the roller 26 on the receiver bracket 23. This is accomplished by removing the receiver bracket bolt 27 from the corresponding receiver bracket arm 23b of the receiver bracket 23 and removing the winch 21 from the receiver bracket 23. The roller 26 can then be removed from the top end of the receiver bracket leg 23a of the receiver bracket 23 by simply lifting it from that position, or removing a pin or bolt (not illustrated) if such pin or bolt is utilized to secure the roller in place. The extending end of the winch mount bracket 20 is then re-inserted in the top end of the receiver bracket leg 23a to mount the winch in the configuration illustrated in FIGS. 4, 5 and 6, while the roller mount leg 25b of the roller mount yoke 25 is similarly re-inserted in the receiver bracket arm 23b of the receiver bracket 23, as further illustrated in FIGS. 4, 5 and 6.

While the preferred embodiments of the invention have been described above, it will be recognized and understood that various modifications may be made in the invention and the appended claims are intended to cover all such modifications which may fall within the spirit and scope of the invention.

1. A lifting and carrying apparatus for a vehicle comprising a substantially vertically-oriented vertical frame having at least one frame leg; a lift frame attached to said frame leg; a frame mount for securing to the vehicle and at least one frame mount leg provided in said frame mount for slidably receiving said frame leg; a winch carried by said frame mount; and a flexible winch line or strap carried by said winch and attached to said lift frame for raising and lowering said vertical frame and said lift frame responsive to operation of said winch.

2. The lifting and carrying apparatus of claim 1 comprising a hinge provided on said frame leg and said lift frame for hingedly connecting said lift frame to said frame leg and selectively pivoting said lift frame from said vertical frame into a substantially horizontal carrying orientation and folding said lift frame against said vertical frame into a substantially vertical orientation.

3. The lifting and carrying apparatus of claim 2 comprising a stabilizing member connected to said vertical frame and said lift frame for strengthening said lift frame when said lift frame is in said substantially horizontal carrying orientation.

4. The lifting and carrying apparatus of claim 1 comprising at least one wheel provided on said lift frame for supporting and carrying cargo on said lift frame.

5. The lifting and carrying apparatus of claim 1 comprising a roller provided on said frame mount in alignment with said winch for receiving and guiding said flexible winch line or strap from said winch to said lift frame.

6. The lifting and carrying apparatus of claim 1 comprising:
(a) a hinge provided on said frame leg and said lift frame for hingedly connecting said lift frame to said frame leg and selectively pivoting said lift frame from said vertical frame into a substantially horizontal carrying orientation and folding said lift frame against said vertical frame into a substantially vertical orientation; and
(b) a roller provided on said frame mount in alignment with said winch, for receiving and guiding said flexible winch line or strap from said winch to said lift frame.

7. The lifting and carrying apparatus of claim 6 comprising a stabilizing member connected to said vertical frame and said lift frame for strengthening said lift frame when said lift frame is in said substantially horizontal carrying orientation.

8. The lifting and carrying apparatus of claim 6 comprising wheels provided on said lift frame for supporting and carrying cargo on said lift frame.

9. A lifting and carrying apparatus for vehicles comprising a substantially vertically-oriented vertical frame having a pair of frame legs; a hinge provided in the bottom ends of said frame legs; a lift frame attached to said hinge at said bottom ends of said frame legs; a frame mount for securing to the vehicle and a pair of frame mount legs provided in said frame mount for slidably receiving said frame legs; a winch carried by said frame mount; a flexible winch line or strap carried by said winch and attached to said lift frame for raising and lowering said vertical frame and said lift frame in concert responsive to operation of said winch; and a roller provided on said frame mount in alignment with said winch, said roller receiving and guiding said flexible winch line or strap from said winch to said lift frame.

10. The lifting and carrying apparatus of claim 9 comprising a stabilizing member connected to said vertical frame and said lift frame for strengthening said lift frame.

11. The lifting and carrying apparatus of claim 10 wherein said stabilizing member comprises a flexible stabilizing line or strap.

12. The lifting and carrying apparatus of claim 9 comprising at least one wheel provided on said lift frame for supporting and carrying cargo on said lift frame.

13. The lifting and carrying apparatus of claim 12 comprising a flexible stabilizing line or strap connected to said frame mount and said lift frame for strengthening said lift frame.

14. A lifting and carrying apparatus for vehicles comprising a substantially vertically-oriented vertical frame having a pair of spaced-apart frame legs; a hinge provided in the bottom ends of said frame legs; a lift frame attached to said hinge at said bottom ends of said frame legs for selectively folding said lift frame against said frame legs and unfolding said lift frame from said frame legs in carrying configuration; a frame mount secured to the vehicle and a pair of frame mount legs provided in said frame mount for slidably receiving said frame legs; a winch carried by said frame mount and a flexible winch line or strap carried by said winch and attached to said lift frame for raising and lowering said vertical frame and said lift frame in concert responsive to operation of said winch; and a pair of wheels provided on said lift frame for supporting and carrying cargo on said lift frame.

15. The lifting and carrying apparatus of claim 14 comprising a stabilizing member connected to said vertical frame and said lift frame for strengthening said lift frame when said lift frame is in said carrying configuration.

16. The lifting and carrying apparatus of claim 15 wherein said stabilizing member comprises a flexible line or strap.

17. The lifting and carrying apparatus of claim 14 comprising a roller provided on said frame mount in alignment with said winch for receiving and guiding said flexible winch line or strap from said winch to said lift frame.

18. The lifting and carrying apparatus of claim 14 comprising an expanded metal deck provided on said lift frame for receiving and carrying cargo.

19. The lifting and carrying apparatus of claim 17 comprising a stabilizing member connected to said vertical frame and said lift frame for strengthening said lift frame when said lift frame is in said carrying configuration.

20. The lifting and carrying apparatus of claim 18 comprising a flexible stabilizing line or strap connected to said frame mount and said lift frame for strengthening said lift frame when said lift frame is in said carrying configuration.
